(19) United States
(12) Patent Application Publication
(10) Pub. No.: US 2022/0223955 A1
(43) Pub. Date: Jul. 14, 2022

(54) HOUSING AND BATTERY HAVING THE SAME

(71) Applicant: Ningde Amperex Technology Limited, Ningde City (CN)

(72) Inventors: Guowen Zhang, Ningde City (CN); Wu Ma, Ningde City (CN); Huifeng Huang, Ningde City (CN); Guicheng Li, Ningde City (CN)

(73) Assignee: Ningde Amperex Technology Limited, Ningde City (CN)

(21) Appl. No.: 17/708,616

(22) Filed: Mar. 30, 2022

Related U.S. Application Data
(63) Continuation of application No. PCT/CN2020/115669, filed on Sep. 16, 2020.

(30) Foreign Application Priority Data
Oct. 10, 2019 (CN) 201921690404.2

(51) Int. Cl. H01M 50/202

(52) U.S. Cl. CPC H01M 50/202

(57) ABSTRACT

A housing includes a first housing and a second housing. The second housing is provided with at least one protrusion, and the first housing includes a bottom wall and a side wall. The side wall is disposed on a peripheral edge of the bottom wall to form an accommodating space together with the bottom wall. The second housing is disposed on a side of the side wall away from the bottom wall, and the at least one protrusion is accommodated in the accommodating space and comes in contact with an inner surface of the side wall.

### CROSS-REFERENCE TO RELATED APPLICATIONS

This application is a national phase entry of International Application No. PCT/CN2020/115669, filed on Sep. 16, 2020, which is incorporated herein by reference in its entirety.

### TECHNICAL FIELD

This application relates to the battery field, and in particular, to a housing and a battery having the housing.

### BACKGROUND

An existing battery generally includes a housing, a cover, a cell, and so on. The cover and the housing are generally positioned by a flange structure, and then are connected together by welding. However, positioning by using the flange structure has the following problems: 1. The flange structure occupies inner space of the battery, which leads to a reduced energy density of the battery. 2. The flange structure features low positioning precision and is prone to weld deviation during welding, which leads to liquid leakage of the battery. 3. Use of the flange structure increases costs of raw materials of the battery.

### SUMMARY

In view of this, it is necessary to provide a housing to resolve the foregoing problems.

A housing in an embodiment is disclosed, the housing includes a first housing and a second housing, where at least one protrusion is disposed in the second housing, and the first housing includes a bottom wall and a side wall disposed on a peripheral edge of the bottom wall to form an accommodating space together with the bottom wall; where the second housing is disposed on a side of the side wall away from the bottom wall, and the at least one protrusion is accommodated in the accommodating space and comes in contact with an inner surface of the side wall.

In some embodiments, the at least one protrusion comprises a plurality of protrusions, and the plurality of the protrusions are arranged in succession.

In some embodiments, the at least one protrusion comprises a plurality of protrusions, and the plurality of the protrusions are arranged in an equidistant intermittent manner or a non-equidistant intermittent manner.

In some embodiments, a cross-section of the at least one protrusion is fan-shaped, oval, triangular, square, pentagonal, or circular.

In some embodiments, a height of the at least one protrusion is not greater than 50 millimeters.

In some embodiments, a distance between an end of the at least one protrusion facing towards the first housing and the side wall is 0 to 100 millimeters.

In some embodiments, the at least one protrusion protrudes from a surface of the second housing facing towards the first housing.

In some embodiments, the at least one protrusion is formed on an inner surface of the second housing, and a groove is formed at a location, corresponding to the at least one protrusion, on an outer surface of the second housing.

A battery in an embodiment is disclosed, the battery includes a cell and the foregoing housing, where the cell is accommodated in the housing.

In some embodiments, the battery further includes a pole, and the pole is disposed on the second housing.

In conclusion, the at least one protrusion of the second housing is accommodated in the accommodating space and comes in contact with the inner surface of the side wall to limit the second housing, thereby implementing precise positioning between the first housing and the second housing, and avoiding liquid leakage caused by weld deviation during welding of the first housing and the second housing. In addition, positioning by using the at least one protrusion also avoids a defect that a conventional positioning structure occupies an internal space of the housing, thereby improving the energy density of the battery. In addition, manufacturing costs of the battery are greatly reduced.

### BRIEF DESCRIPTION OF DRAWINGS

FIG. 1 is a schematic cross-sectional diagram of a housing according to Embodiment 1 of this application;

FIG. 2 is an enlarged view of a position II shown in FIG. 1;

FIG. 3 is a schematic partial cross-sectional diagram of a housing in another implementation according to Embodiment 1 of this application;

FIG. 4 is a top view of a second housing according to an implementation of this application;

FIG. 5 is a top view of a second housing according to another implementation of this application;

FIG. 6 is a top view of a second housing according to still another implementation of this application;

FIG. 7 is a schematic cross-sectional diagram of a battery according to an implementation of this application;

FIG. 8 is a schematic cross-sectional diagram of a housing according to Embodiment 2 of this application;

FIG. 9 is a schematic partial cross-sectional diagram of a housing in another implementation according to Embodiment 2 of this application;

FIG. 10 is a schematic partial cross-sectional diagram of a housing according to Embodiment 3 of this application;

FIG. 11 is a schematic partial cross-sectional diagram of a housing in another implementation according to Embodiment 3 of this application;

FIG. 12 is a schematic partial cross-sectional diagram of a housing according to Embodiment 4 of this application;

FIG. 13 is a schematic partial cross-sectional diagram of a housing in another implementation according to Embodiment 4 of this application;

FIG. 14 is a schematic partial cross-sectional diagram of a housing according to Embodiment 5 of this application; and

FIG. 15 is a schematic partial cross-sectional diagram of a housing in another implementation according to Embodiment 5 of this application;

### REFERENCE NUMERALS OF MAIN COMPONENTS

Battery 100
Housing 10
First housing 11
Bottom wall 111
Side wall 112
Accommodating space 113
Second housing 12
Inner surface 121
Outer surface 122
Groove 123
Protrusion 13
Injection plug 14
Cell 20
Negative electrode plate 201
Positive electrode plate 202
Separator 203
Negative tab 204
Positive tab 205
Pole 30
First protection element 40
Second protection element 50
Height H
Distance L
Depth D

This application will be further described with reference to the accompanying drawings in the following specific embodiments.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

Unless otherwise defined, all technical and scientific terms used herein shall have the same meanings as commonly understood by those skilled in the art to which this application belongs. The terms used in the specification of this application are merely intended to describe specific embodiments but not intended to constitute any limitation on this application.

Some implementations of this application are described in detail below with reference to the accompanying drawings. In absence of conflicts, the following embodiments and features in the embodiments may be combined.

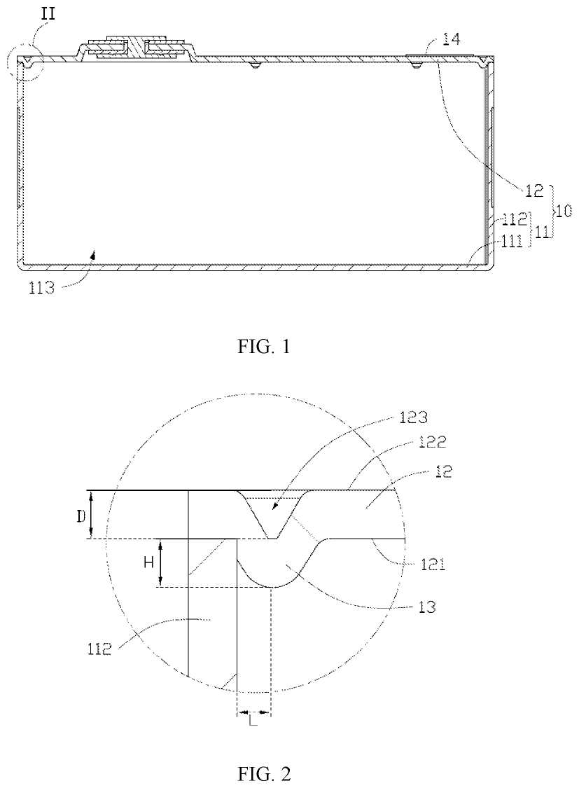

Referring to FIG. 1, an implementation of this application provides a housing 10. The housing 10 includes a first housing 11 and a second housing 12.

The first housing 11 includes a bottom wall 111 and a side wall 112. The side wall 112 is disposed on a peripheral edge of the bottom wall 111 to form an accommodating space 113 together with the bottom wall 111. A shape of the bottom wall 111 may be adaptively adjusted based on an actual requirement, and may be a regular shape such as a rectangle, a triangle, or a circle, or another irregular shape.

In this implementation, a material of the first housing 11 may be metal, plastic, or a composite material of metal and plastic. The metal may be selected from one or more of materials such as steel alloy, aluminum alloy, iron alloy, copper alloy, and other metals.

As shown in FIG. 1 and FIG. 2, the second housing 12 is provided with at least one protrusion 13.

The second housing 12 is disposed on a side of the side wall 112 away from the bottom wall 111, and the at least one protrusion 13 is accommodated in the accommodating space 113 and comes in contact with an inner surface of the side wall 112. In this way, precise positioning is implemented between the first housing 11 and the second housing 12 through limitation of the at least one protrusion 13. Specifically, a surface of the at least one protrusion 13 in the accommodating space 113 includes an arc face and a plat face. The inner surface of the side wall 112 is a plane, and the flat face of the at least one protrusion 13 is in contact with the inner surface of the side wall 112. In this implementation, the first housing 11 and the second housing 12 are secured by welding.

In this implementation, a shape of the second housing 12 may be adaptively adjusted based on the shape of the bottom wall 111 or other actual requirements, and may be a regular shape such as a rectangle, a triangle, or a circle, or other irregular shapes. A material of the second housing 12 may be metal, plastic, or a composite material of metal and plastic. The metal may be selected from one or more of materials such as steel alloy, aluminum alloy, iron alloy, copper alloy, and other metals.

As shown in FIG. 1 and FIG. 2, the second housing 12 includes an inner surface 121 and an outer surface 122 away from the inner surface 121. The inner surface 121 faces towards the first housing 11. In this implementation, the at least one protrusion 13 is formed on the inner surface 121, and a groove 123 is formed at a location, corresponding to the at least one protrusion 13, on the outer surface 122. In this implementation, a cross-section of the at least one protrusion 13 is fan-shaped, oval, triangular, square, pentagonal, circular, or polygonal. A height H of the at least one protrusion 13 is not greater than 50 millimeters. A distance L between an end of the at least one protrusion 13 facing towards the first housing 11 and the side wall 112 is 0 to 100 millimeters. A depth D of the groove 123 is not greater than 100 mm. The at least one protrusion 13 may be formed by punching the outer surface 122 of the second housing 12.

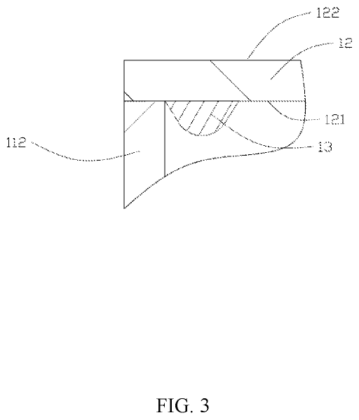

Referring to FIG. 3, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

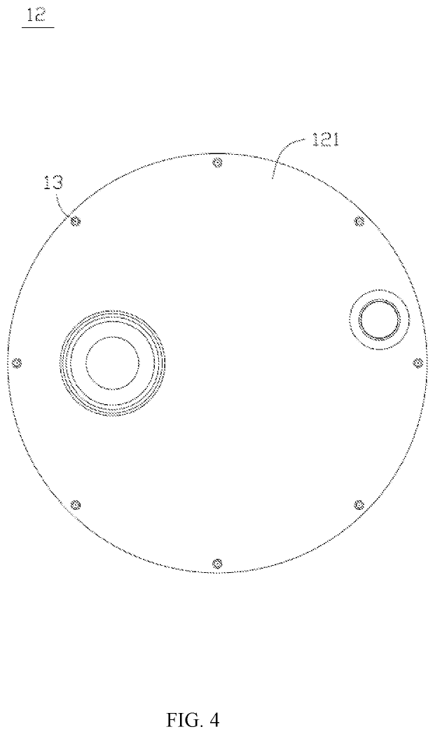

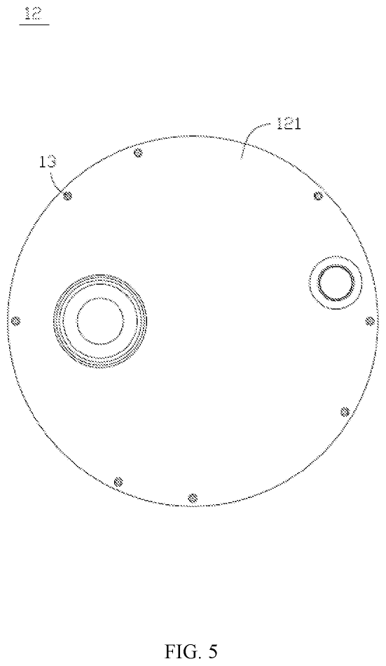

Referring to FIG. 4, in an implementation, a plurality of protrusions 13 are disposed on the second housing 12, and the plurality of protrusions 13 are arranged in an equidistant intermittent manner, or may be arranged in a non-equidistant intermittent manner, as shown in FIG. 5.

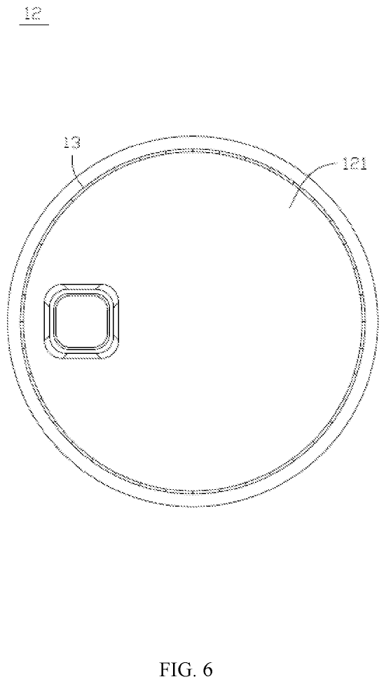

Referring to FIG. 6, in another implementation, the at least one protrusion includes a plurality of protrusions 13. The plurality of the at least one protrusions 13 are arranged in succession. Certainly, the second housing 12 may alternatively include one protrusion 13, and the at least one protrusion 13 is annular or circular.

Referring to FIG. 4, in this implementation, the second housing 12 includes eight protrusions 13. The eight protrusions 13 are disposed on the inner surface 121 of the second housing 12, and are arranged in an equidistant intermittent manner. In this way, precise positioning is implemented between the first housing 11 and the second housing 12 through limitation of the protrusions 13. The first direction and the second direction are perpendicular to each other.

Referring to FIG. 5, in an implementation, the eight protrusions 13 are arranged in a non-equidistant intermittent manner. In another implementation, a quantity of protrusions 13 is not limited, and may be one, two, three, four, five, six, seven, nine, ten, or the like.

Referring to FIG. 1, in this implementation, an injection hole (not shown in the figure) may further be provided in the housing 10, and the injection hole may be located in the first housing 11 or the second housing 12. An electrolyte may be injected through the injection hole. The injection hole is provided with an injection plug 14, and the injection plug 14 is configured to seal the injection hole, so as to prevent leakage of the injected electrolyte or prevent external impurities from entering the housing 10.

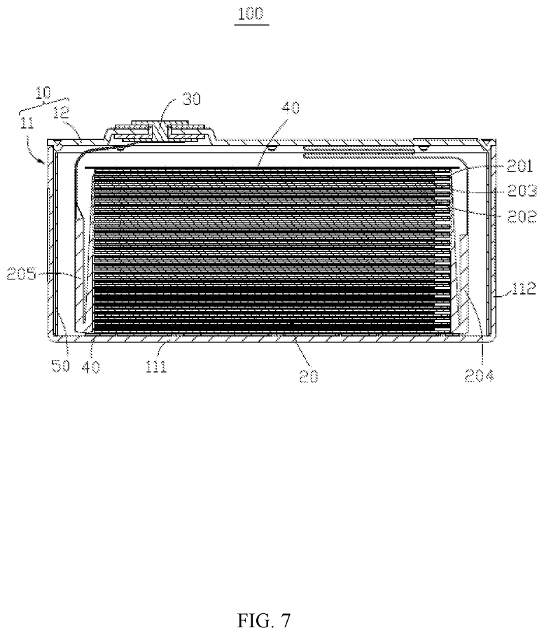

Referring to FIG. 7, an implementation of this application further provides a battery 100. The battery 100 includes the housing 10 and a cell 20. The cell 20 is accommodated in the housing 10. The battery 100 may be a button battery, and a material of the housing of the battery 100 may be steel. In an implementation, the cell 20 may be a laminated core or a wound core.

The battery 100 further includes a pole 30. The pole 30 is disposed on the second housing 12. In this implementation, the cell 20 may include a negative electrode plate 201, a positive electrode plate 202, and a separator 203 disposed between the negative electrode plate 201 and the positive electrode plate 202. The negative electrode plate 201, the positive electrode plate 202, and the separator 203 are laminated to form the cell 20. The negative electrode plate 201 includes a negative current collector and a negative active material layer formed on a surface of the negative current collector. The positive electrode plate 202 includes a positive current collector and a positive active material layer formed on a surface of the positive current collector. The negative current collector and the positive current collector may be respectively connected to the negative tab 204 and the positive tab 205 by welding. The negative tab 204 may be connected to the first housing 11 or the second housing 12 by welding, and the positive tab 205 may be connected to the pole 30 by welding, so that the pole 30 and the second housing 12 present opposite polarity.

In this implementation, the battery 100 further includes a first protection element 40 accommodated in the housing 10. The first protection element 40 is located between the cell 20 and the housing 10. Specifically, there are two first protection elements 40. One of the first protection elements 40 is disposed above the cell 20 and located between the cell 20 and the inner surface 121 of the second housing 12, and is configured to isolate the cell 20 from the second housing 12 and prevent the pole 30 from piercing through the plate of the cell 20. The other first protection element 40 is disposed below the cell 20 and located between the cell 20 and the bottom wall 111 of the first housing 11, and is configured to isolate the cell 20 from the bottom wall 111 of the first housing 11.

The battery 100 further includes a second protection element 50 accommodated in the housing 10. The second protection element 50 surrounds an outer circumference of the cell 20. The second protection element 50 is configured to isolate the cell 20 from the second housing 12. The second protection element 50 may be substantially annular, so as to surround the outer circumference of the cell 20.

This application is described in detail below by using the embodiments.

### Embodiment 1

Referring to FIG. 1, the housing 10 includes the first housing 11 and the second housing 12.

The first housing 11 includes the bottom wall 111 and the side wall 112. The side wall 112 is disposed on the peripheral edge of the bottom wall 111 to form the accommodating space 113 together with the bottom wall 111. In this implementation, the bottom wall 111 is circular.

Also referring to FIG. 2, the second housing 12 is provided with the at least one protrusion 13. The second housing 12 is disposed on the side of the side wall 112 away from the bottom wall 111, and the at least one protrusion 13 is disposed in the accommodating space 113 and comes in contact with the inner surface of the side wall 112. In this implementation, the first housing 11 is circular.

The second housing 12 includes the inner surface 121 and the outer surface 122 away from the inner surface 121. The inner surface 121 faces towards the first housing 11. In this implementation, the at least one protrusion 13 is formed on the inner surface 121, and the groove 123 is formed at the location, corresponding to the at least one protrusion 13, on the outer surface 122. The at least one protrusion 13 may be formed by punching the outer surface 122 of the second housing 12. The cross-section of the at least one protrusion 13 is fan-shaped. A diameter of the fan shape is not greater than 1000 mm.

Referring to FIG. 3, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

### Embodiment 2

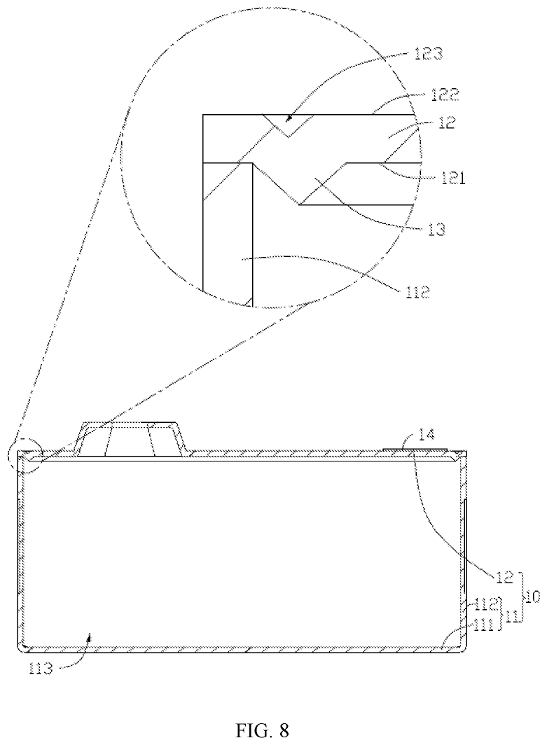

Referring to FIG. 8, a difference between Embodiment 2 and Embodiment 1 lies in that the cross-section of the at least one protrusion 13 is triangular. The at least one protrusion 13 may be formed by punching the outer surface 122 of the second housing 12.

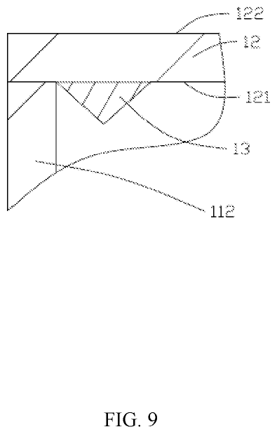

Referring to FIG. 9, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

### Embodiment 3

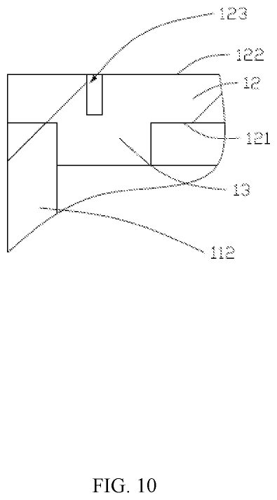

Referring to FIG. 10, a difference between Embodiment 3 and Embodiment 1 lies in that the cross-section of the at least one protrusion 13 is square. The at least one protrusion 13 may be formed by punching the outer surface 122 of the second housing 12.

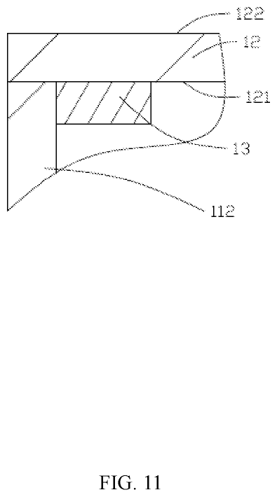

Referring to FIG. 11, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

### Embodiment 4

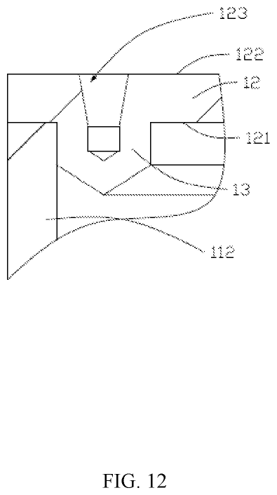

Referring to FIG. 12, a difference between Embodiment 4 and Embodiment 1 lies in that the cross-section of the at least one protrusion 13 is pentagonal. The at least one protrusion 13 may be formed by punching the outer surface 122 of the second housing 12.

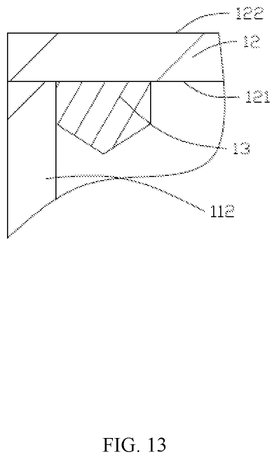

Referring to FIG. 13, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

### Embodiment 5

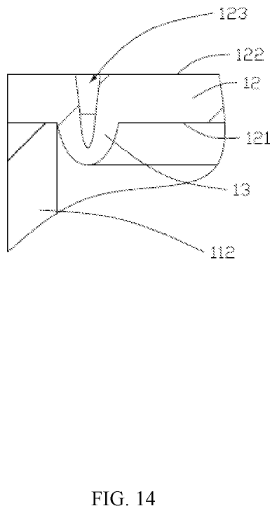

Referring to FIG. 14, a difference between Embodiment 5 and Embodiment 1 lies in that the cross-section of the at least one protrusion 13 is substantially semicircular. The at least one protrusion 13 may be formed by punching the outer surface 122 of the second housing 12.

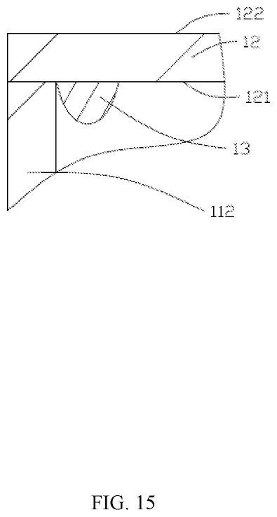

Referring to FIG. 15, in another implementation, the at least one protrusion 13 protrudes from the inner surface 121 of the second housing 12. The at least one protrusion 13 may be formed on the inner surface 121 of the second housing 12 by using a process such as bonding or welding. In another implementation, the at least one protrusion 13 and the second housing 12 may alternatively be formed integrally.

In conclusion, the at least one protrusion 13 of the second housing 12 is accommodated in the accommodating space 113 and comes in contact with the inner surface of the side wall 112 to limit the second housing 12, thereby implementing precise positioning between the first housing 11 and the second housing 12, and avoiding liquid leakage caused by weld deviation during welding of the first housing 11 and the second housing 12. In addition, positioning by using the at least one protrusion 13 also avoids a defect that a conventional positioning structure occupies an internal space of the housing 10, thereby improving the energy density of the battery 100. Furthermore, manufacturing costs of the battery 100 are greatly reduced.

The foregoing embodiments are merely intended to describe the technical solutions of this application, but not intended to constitute any limitation. Although this application is described in detail with reference to embodiments, persons of ordinary skill in the art should understand that modifications or equivalent replacements can be made to the technical solutions of this application, without departing from the spirit and essence of the technical solutions of this application.

What is claimed is:

1. A housing, comprising: a first housing and a second housing, wherein at least one protrusion is disposed in the second housing; and
the first housing comprises a bottom wall and a side wall disposed on a peripheral edge of the bottom wall to form an accommodating space together with the bottom wall;
wherein the second housing is disposed on a side of the side wall away from the bottom wall, and the at least one protrusion is accommodated in the accommodating space and comes in contact with an inner surface of the side wall.

2. The housing according to claim 1, wherein the at least one protrusion comprises a plurality of protrusions, and the plurality of the protrusions are arranged in succession.

3. The housing according to claim 1, wherein the at least one protrusion comprises a plurality of protrusions, and the plurality of the protrusions are arranged in an equidistant intermittent manner or a non-equidistant intermittent manner.

4. The housing according to claim 1, wherein a cross-section of the at least one protrusion is fan-shaped, oval, triangular, square, pentagonal, or circular.

5. The housing according to claim 1, wherein a height of the at least one protrusion is not greater than 50 millimeters.

6. The housing according to claim 1, wherein a distance between an end of the at least one protrusion facing towards the first housing and the side wall is 0 to 100 millimeters.

7. The housing according to claim 1, wherein the at least one protrusion protrudes from a surface of the second housing facing towards the first housing.

8. The housing according to claim 1, wherein the at least one protrusion is formed on an inner surface of the second housing, and a groove is formed at a location, corresponding to the at least one protrusion, on an outer surface of the second housing.

9. A battery, comprising a cell, wherein the battery further comprises a housing, the cell is accommodated in the housing, and the housing comprises a first housing and a second housing, wherein at least one protrusion is disposed in the second housing; and
the first housing comprises a bottom wall and a side wall disposed on a peripheral edge of the bottom wall to form an accommodating space together with the bottom wall;
wherein the second housing is disposed on a side of the side wall away from the bottom wall, and the at least one protrusion is accommodated in the accommodating space and comes in contact with an inner surface of the side wall.

10. The battery according to claim 9, wherein the at least one protrusion comprises a plurality of protrusions, and the plurality of the protrusions are arranged in succession.

11. The battery according to claim 9, wherein the at least one protrusion comprises a plurality of protrusions, and the plurality of the protrusions are arranged in an equidistant intermittent manner or a non-equidistant intermittent manner.

12. The battery according to claim 9, wherein a cross-section of the at least one protrusion is fan-shaped, oval, triangular, square, pentagonal, or circular.

13. The battery according to claim 9, wherein a height of the at least one protrusion is not greater than 50 millimeters.

14. The battery according to claim 9, wherein a distance between an end of the at least one protrusion facing towards the first housing and the side wall is 0 to 100 millimeters.

15. The battery according to claim 9, wherein the at least one protrusion protrudes from a surface of the second housing facing towards the first housing.

16. The battery according to claim 9, wherein the at least one protrusion is formed on an inner surface of the second housing, and a groove is formed at a location, corresponding to the at least one protrusion, on an outer surface of the second housing.

17. The battery according to claim 9, wherein the battery further comprises a pole, and the pole is disposed on the second housing.
